(19) United States
(12) Patent Application Publication
(10) Pub. No.: US 2023/0072473 A1
(43) Pub. Date: Mar. 9, 2023

(54) CORROSION INHIBITOR FOR A CENTRAL HEATING SYSTEM

(71) Applicant: ADEY HOLDINGS (2008) LIMITED, Haresfield, Stonehouse (GB)

(72) Inventor: Mo JASSAL, Haresfield, Stonehouse (GB)

(21) Appl. No.: 17/795,452

(22) PCT Filed: Jan. 20, 2021
(86) PCT No.: PCT/GB2021/050126

§ 371 Date: Jul. 26, 2022

(30) Foreign Application Priority Data
Jan. 27, 2020 (GB) 2001089.8

(51) Int. Cl. C23F 11/14; C23F 11/18

(52) U.S. Cl. CPC C23F 11/141; C23F 11/18

(57) ABSTRACT

A corrosion inhibitor for a central heating system is provided in the form of a cream having low water content, which may be encapsulated within a water-soluble film, for example a poly (vinyl alcohol) film. The corrosion inhibitor product is more highly-concentrated than known liquid inhibitors, and the encapsulation in a water soluble film provides for safer handling and eliminates waste from plastic packaging.

The present invention relates to a corrosion inhibitor, particularly for a central heating system or cooling system.

### BACKGROUND TO THE INVENTION

It is well known to dose the heating fluid of a central heating system with a corrosion inhibitor, to reduce corrosion of system components such as radiators and pipework. By reducing corrosion, contamination of the heating fluid with solid particles is reduced, avoiding damage that the solid particles would otherwise cause by clogging radiators or heat exchangers, and damaging pumps.

Known inhibitor products include a blend of chemicals which include both liquid and powder ingredients and both organic and inorganic compounds. Organic solvents are added in order to dissolve the organic powder ingredients into the product. The result is a homogenous water-based liquid which mixes readily and completely into the water forming the heating fluid in the central heating or cooling system.

Almost all chemical inhibitor products are provided as a liquid, typically in bottles from around 285 ml to 4000 ml. A typical domestic heating system may contain about 100-125 litres of system water, and can be effectively treated with a dose of around 300 ml of concentrated inhibitor. The most concentrated corrosion inhibitor formula currently available on the market is sold under the trade mark Adey MC1+ Rapide and is dosed at 0.24% v/v, so a 300 ml bottle will treat many typical domestic small-to-medium-sized systems. This corresponds to around 60% active ingredients, 40% water and other solvents in Adey MC1+ Rapide.

The liquid inhibitor products currently available are introduced into the heating system either by pouring into the feed & expansion tank (in open vented systems) or by adding to radiators or filters by pouring in or using a pressurised cannister.

Inhibitors typically include multiple ingredients which protect against various types of corrosion, for example, anodic and cathodic electrolytic corrosion as well as oxidization due to oxygen dissolved in the heating fluid. The organic compounds typically comprised in inhibitors include benzotriazole, amines and glycol. Typical water-soluble ingredients include sodium molybdate and sodium gluconate.

It would be advantageous to further concentrate inhibitor products, because this would save on packaging and transport costs and be beneficial to the environment. However, beyond the concentration level of 0.24% v/v solutions become unstable due to saturation and the powder components precipitate or crystallise out.

When handling a liquid product, there is a risk that the chemical inhibitor comes into contact with skin or eyes, posing a safety risk. Liquid may also be spilled, especially if packaging is inadvertently damaged in transport.

It is known to provide a chemical inhibitor in the form of a solid, dissolvable tablet. For example, a solid tablet product is sold under the trade mark Flamco RedProtect RP1. However, solid tablet products can incompletely dissolve, and clumps of undissolved material could cause clogging in a heating system. Although this type of product goes some way to addressing safety and environmental concerns with liquid products, the tablets have to be protected by plastic packaging which is not always easy to recycle, and contact with skin is still possible.

It is an object of the invention to reduce the above-mentioned problems.

### SUMMARY OF THE INVENTION

According to a first aspect of the present invention, there is provided a method of manufacturing a corrosion inhibitor product for a central heating system, the corrosion inhibitor including a plurality of ingredients, the plurality of ingredients including both organic and inorganic compounds, and the method comprising the steps of:
(a) dividing the ingredients into groups, including at least a first group of ingredients all of which are water soluble, and a second group of ingredients all of which are soluble in an organic solvent which is miscible in or with water;
(b) dissolving the ingredients of the first group in water to make a first solution;
(c) separately dissolving the second group of ingredients in the organic solvent to make a second solution;
(d) mixing together the first solution and the second solution.

The result of the method is a homogenous liquid, gel or cream (or, more generally, an emulsion) which is completely miscible in the central heating system water. It is found that by separating the ingredients into two groups and mixing them separately, and then combining the mixtures, the amount of water and organic solvent required is reduced compared with known corrosion inhibitor products. In other words, the inhibitor concentration is much increased. This allows a suitable dosing ratio of, for example, less than 0.15% v/v. As a result, a total volume of product of less than 200ml will be suitable for dosing many domestic and small commercial central heating systems.

The ingredients in the first group may include for example sodium molybdate and sodium gluconate. The ingredients in the second group may include for example benzotriazole, one or more amines and glycol. The one or more amines may be liquid at room temperature. The one or more amines may provide corrosion inhibition and/or pH buffering in central heating system water.

It is believed that an organic solvent which can hydrogen bond with water may be useful for forming the homogenous product.

Using an amine (or amines) as the organic solvent is preferred in some embodiments. An amine has a nitrogen with a lone pair of electrons which allows for hydrogen bonding with water or protonation for acid-base behaviour.

There are various types of amines that may be used, particularly as corrosion inhibitors. For example, one or more diamines or triamines may be used. In some embodiments, one or more primary amines may be used. In some embodiments, one or more secondary or tertiary amines, such as cyclic amines, may be used instead or as well.

In terms of substituents on the nitrogen in the amine(s), at least one of the substituents may include an amino, methoxy or hydroxy group. The amino, methoxy or hydroxy group may be a terminal group. The substituent(s) may include a carbon chain or ring.

For example, one or more of the following types of amines may be suitable for use in the second group of ingredients: one or more amino alcohols such as ethanolamine (for example, monoethanolamine or dimethylethanolamine) and dimethylisopropanolamine; one or more alkyl amines such as trimethylamine and methoxypropylamine; one or more diamines such as ethylenediamine; and one or more cyclic amines such as morpholine, pyridines and alkyl pyridines (also known as picolines). Other types of amines or specific amines are also contemplated as being suitable for carrying out the invention.

In embodiments, various other ingredients may be included, for example ingredients which directly prevent some type of corrosion, or other ingredients which act as stabilisers, tracers etc. and thus need to be mixed into the finished product, although they do not directly prevent corrosion.

Active ingredients in the corrosion inhibitor product may form for example around 85-90% of the product by volume, with the remaining 10-15% by volume being water.

For example, in one embodiment a corrosion inhibitor product contains around 2.5% benzotriazole, 40% amine, 10% sodium molybdate, 10% sodium gluconate, 15% water, a small amount of polymer and a small amount of preservative, and around 20% proprietary active ingredients. The amine provides a dual function of non-aqueous solvent and inhibitor. The total formulation with only around 15% or less water content provides for a highly concentrated homogenous cream.

The cream or emulsion may be viscous or quite thick due to the relatively low water content. However, it should still ideally have flow characteristics which make it suitable for use in a chemical dosing device or system, such as the automated dosing means disclosed in the Applicant’s co-pending patent application GB2010814.8.

Mixing together the first solution and the second solution should be done quickly, to form a concentrated homogenous cream or gel product.

Mixing the solutions in step (d) may form a homogenous product containing around 20% or less water, and preferably around 15% or less water.

When mixing the solutions, the solutions may be provided in a ratio of at least about 2:1 (second solution : first solution). Put another way, there may be about twice the volume of organic solvent (or more) in the second solution compared to the volume of water in the first solution. Higher ratios may be used to prepare a homogenous product or cream with the desired amounts of ingredients but having a relatively lower water content.

The concentrated homogenous cream resulting from the process may be encapsulated in a soluble film, for example a water-soluble polymer film such as poly (vinyl alcohol). Because of the high concentration and low water content of the corrosion inhibitor, it is possible to encapsulate it in such a film without the risk that the film will be dissolved by its contents. Prior art liquid corrosion inhibitors have had a water content which is too high to allow this.

The cream may be provided in a container such as a tube. The tube may be a squeeze tube or collapsible tube. That is, the tube may be compressible for squeezing the cream out for the tube, typically by hand. The tube may have a cap or other suitable seal at its outlet. The seal may be reusable or re-sealable.

The cream may be provided in a container such as a canister or pressure container, for example an aerosol can. A suitable carrier gas or fluid may also be provided in the container for spraying the cream, if the cream is stored under pressure.

The first solution and the second solution may be produced at a temperature of around 50-60° C. Maintaining the solvents at this temperature ensures that the individual ingredients dissolve completely.

The first solution may be a saturated (or near-saturated) solution. The ingredients in the first group may be dissolved in substantially a minimum amount of water, for the masses of ingredients used, to make the first solution. Preferably, the first solution is a supersaturated solution. The first solution may be heated to fully dissolve the first group ingredients in an amount of water which would not, at ambient or room temperature, fully dissolve the same.

The concentrated cream once mixed may be cooled before encapsulating it in the soluble film. For example, the homogenous product may be allowed to cool to around room temperature.

The result is a cream / gel capsule which can be conveniently handled and transported. For example, a quantity of cream/gel capsules could be packaged in a cardboard box. The fuel used in transporting the product to merchants and finally to customers is reduced, as is the space taken up in shops, warehouses, and vehicles. When all the capsules have been used the cardboard box may be readily recycled.

Suitable soluble films can be made which are highly resistant to accidental damage, and therefore a cream / gel capsule-based product is safer and more convenient to handle than prior art liquid-based inhibitors. The risk of splashing liquid into skin or eyes is much reduced.

When the capsule is added to central heating system water, for example via a feed and expansion tank or into a filter, the soluble film will dissolve in a matter of minutes. The cream / gel is released into the central heating system water and disperses evenly and quickly within the system. This happens much more quickly than with known solid tablet-based products, providing immediate protection for the heating system without the risk of forming clumps of material which may clog the system.

Note that the terms “cream” and “gel” are used roughly synonymously. The product is a liquid or emulsion which is low in water content so that it does not dissolve the soluble film. The exact characteristics will depend on the ingredients used, which may vary in different embodiments.

According to a second aspect of the invention, there is provided a corrosion inhibitor product for a central heating system, the corrosion inhibitor product comprising:

a homogenous cream which includes
at least 30% or 35% amine;
at least 5% sodium molybdate;
at least 5% sodium gluconate;
less than 20% water,
the homogenous cream being encapsulated in a water-soluble film or provided in a container.

The soluble film may be a polymer film such as poly (vinyl alcohol).

Preferably the cream includes at least 40% amine. The amine ingredient acts both as an inhibitor and as a solvent for other organic ingredients.

Preferably the cream includes at least 10% sodium molybdate.

Preferably the cream includes at least 10% sodium gluconate.

Preferably the cream includes at most 15% water.

According to a third aspect of the invention, there is provided a method of protecting a central heating system from corrosion, the method comprising introducing a corrosion inhibitor product according to the second aspect of the invention into the central heating system.

The corrosion inhibitor product - i.e. the homogenous cream encapsulated in a water-soluble film - is preferably introduced into the central heating system via a dosing pot. A dosing pot may be provided exclusively for that purpose, or may also provide a filtration function. For example, many magnetic filters, including those sold under the brand “Adey Magnaclean” (RTM) may be used for dosing the central heating system with corrosion inhibitor “capsules” in this way.

Any feature or features presented with respect to one aspect of the invention may be independently provided in another aspect of the invention.

### DESCRIPTION OF THE DRAWINGS

For a better understanding of the invention, and to show more clearly how it may be carried into effect, specific embodiments will now be described with reference to the accompanying drawings in which:

FIG. 1 is a flow chart illustrating the method of the first aspect of the invention; and

FIG. 2 shows a corrosion inhibitor product according to the second aspect of the invention being used to protect a central heating system according to the method of the third aspect of the invention.

### DESCRIPTION OF THE EMBODIMENTS

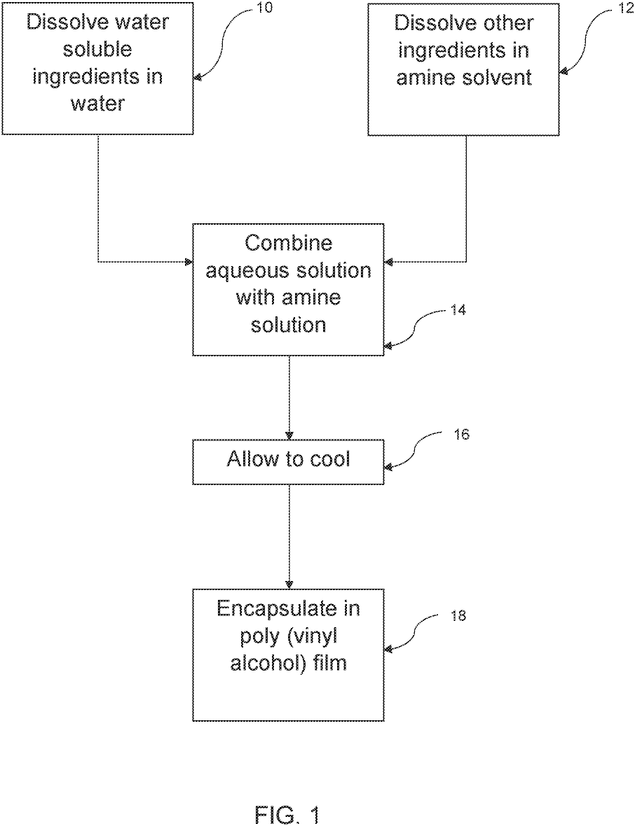

The process of making a corrosion inhibitor product suitable for use in protecting a central heating system is briefly set out in the flow chart in FIG. 1.

In step 10 a first solution is made by dissolving water soluble ingredients in water. The water-soluble ingredients may include sodium molybdate and sodium gluconate. The first solution may contain around 40% - 50% water by volume, with the remainder being mostly sodium molybdate and sodium gluconate in about equal measure. In some embodiments further water-soluble components may also be included. The water is heated to at least about 50° C. to ensure complete dissolution of the water-soluble ingredients.

In step 12 a second solution is made by dissolving non-water-soluble ingredients in an organic solvent. The solvent may be an amine which as well as acting as a solvent also works as an inhibitor. Benzotriazole, various amines, and glycol are examples of ingredients which may be mixed together to form the second solution. Again, the solvent(s) are preferably heated to around 50° C. or more to ensure complete dissolution.

In step 14 the first solution and the second solution are combined. This is done quickly to ensure complete mixing to form a homogenous product. It is found that when the first and second solution are combined, a stiff aqueous cream is quickly formed. This is a stable product which can be allowed to cool (step 16) and stored at room temperature.

At step 18 a dose of cream is encapsulated in a water-soluble film. The film may be for example made from poly (vinyl alcohol). Encapsulating creams in soluble films is known, for example, for creating “pouches” containing laundry detergent. The cream created by steps 10, 12 and 14 has sufficiently low water content that it can be encapsulated in such films, which is so far unknown for a central heating corrosion inhibitor. In other embodiments, one or multiples doses of cream may be provided in a tube or other container.

The cream may be sufficiently concentrated that a typical domestic heating system may require a dose of around 200 ml. It is envisaged that a “pouch” could be made containing about 50 ml, so that dosing a heating system could use for example four tablets. Alternatively, smaller pouches could be made to reasonably accurately correspond with the amount of inhibitor needed to dose one radiator, or radiators heating one room. This allows for very easy estimation of the correct amount with which to dose a central heating system. For example, a good approximation of the dose required might be around 30 ml multiplied by the number of radiators in the system. If the inhibitor is provided in 30 ml pouches, then a heating engineer simply needs to count the number of radiators and dose the system with that number of tablets. This may provide a much more accurate way of estimating the correct dose than with existing liquids, which are often provided in bottles of around 300 ml which are supposed to be suitable for a “typical domestic system”. “Typical domestic systems” in fact vary in size quite a lot, wasting chemical in smaller systems and potentially under-dosing larger systems. By providing the chemical in small dose pouches, this problem is avoided.

It will be appreciated that larger, perhaps much larger, pouches may be produced to suit larger central heating systems.

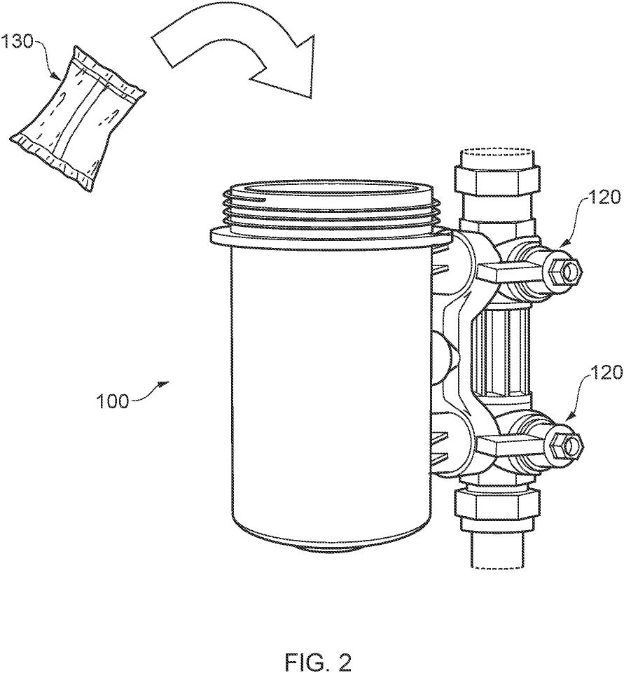

A pouch of around 30ml may also be easily introduced into a dosing pot or magnetic filter. FIG. 2 shows the Adey MagnaClean (RTM) Professional 2 filter with the lid removed. The filter is indicated generally at 100. The filter is isolated from the flow and return of the central heating circuit by closing valves 120, and then the lid (not shown) is removed. The magnet is also removed, which will leave some space in the canister, i.e. the canister will not be completely full of water. At this point a pouch 130 made according to the process of FIG. 1 may be introduced. The water-soluble film will dissolve, releasing the inhibitor chemical into the central heating system water.

Where a tube or other container is used in other embodiments, the cream may be squeezed or sprayed or otherwise dispensed from the container and introduced into the central heating system water. It will then become distributed or dispersed in the central heating system water.

The corrosion inhibitor product of the invention allows for desired amounts of inhibitor chemicals to be formulated together in a product which has a significantly lower amount of solvent, particularly water, and thus a significantly higher relative concentration of inhibitor chemicals compared to prior art formulations. The amounts of inhibitor chemicals or ingredients can be varied as needed, subject to being suitably dissolvable in the amounts of the respective solvents used.

The corrosion inhibitor pouches of the invention provide for a corrosion inhibitor which generates less plastic waste, is safer to handle, and is smaller and lighter making it more efficient to store and transport. Doses can be more accurately estimated to make the best use of the chemical to protect different sized heating systems.

1-25. (canceled)

26. A method of manufacturing a corrosion inhibitor product for a central heating system, the corrosion inhibitor including a plurality of ingredients, the plurality of ingredients including both organic and inorganic compounds, and the method comprising the steps of:
(a) dividing the ingredients into groups, including at least a first group of ingredients all of which are water soluble, and a second group of ingredients all of which are soluble in an organic solvent which is miscible in water;
(b) dissolving the ingredients of the first group in water to make a first solution;
(c) separately dissolving the second group of ingredients in the organic solvent to make a second solution;
(d) mixing together the first solution and the second solution.

27. The method as claimed in claim 26, in which the ingredients of the first group include one or both of sodium molybdate and sodium gluconate.

28. The method as claimed in claim 26, in which the ingredients of the second group include benzotriazole.

29. The method as claimed in claim 26, in which the ingredients of the second group include at least one amine.

30. The method as claimed in claim 26, in which the organic solvent is an amine which is miscible in water.

31. The method as claimed in claim 26, in which the ingredients of the second group include glycol.

32. The method as claimed in claim 26, further comprising the step of:
(e) encapsulating the mixture of the first solution and the second solution in a water-soluble film.

33. The method as claimed in claim 32, in which the water-soluble film is poly (vinyl alcohol).

34. The method as claimed in claim 26, in which the first solution is produced at a temperature of at least 40 or 45° C. or at least 50° C.

35. The method as claimed in claim 26, in which the second solution is produced at a temperature of at least 40 or 45° C. or at a temperature of at least 50 degrees.

36. The method as claimed in claim 32, in which the mixture of the first solution and the second solution is cooled before encapsulating the mixture in the film.

37. The method as claimed in claim 26, in which mixing the solutions in step (d) forms a homogenous product containing 20% or less water content by volume.

38. A corrosion inhibitor product for use in protecting a central heating system, the corrosion inhibitor product comprising:
a homogenous cream which includes:
at least 30% or 35% amine by volume;
at least 5% sodium molybdate by volume;
at least 5% sodium gluconate by volume;
less than 20% water by volume,
the homogenous cream being encapsulated in a water-soluble film or provided in a container.

39. The corrosion inhibitor product as claimed in claim 38, in which the water-soluble film is a polymer film or a poly (vinyl alcohol) film.

40. The corrosion inhibitor product as claimed in claim 38, which contains at least 40% amine by volume.

41. The corrosion inhibitor product as claimed in claim 38, which contains one or both of: at least 10% sodium molybdate by volume, and at least 10% sodium gluconate by volume.

42. The corrosion inhibitor product as claimed in claim 38, which contains at most 20% water by volume.

43. A method of protecting a central heating system from corrosion, the method comprising introducing a corrosion inhibitor product according to claim 38 into the central heating system fluid.

44. The method of protecting a central heating system as claimed in claim 43, in which the corrosion inhibitor product is introduced into the system via a dosing pot.

45. The method of protecting a central heating system as claimed in claim 44, in which the dosing pot is a magnetic filter.
